(19) United States
(12) Patent Application Publication
(10) Pub. No.: US 2008/0180720 A1
(43) Pub. Date: Jul. 31, 2008

(54) SYSTEM AND METHOD FOR GENERATING CUSTOMIZABLE SEPARATOR PAGES

(76) Inventors: Tony Quach, Anaheim, CA (US); Peter Tran, Garden Grove, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/669,788

(22) Filed: Jan. 31, 2007

(51) Int. Cl. G06F 15/00

(52) U.S. Cl. 358/1.15

(57) ABSTRACT

The subject application is directed to a system and method for generating a separator page. A document output instruction is received corresponding to the generation of a tangible document from an electronic document. A separator page instruction is then received. An output destination instruction corresponding to the electronic document, corresponding to a selected output destination for the tangible document is then received. A separator page is then generated in accordance with the received separator page generation instruction. The electronic document is then routed so as to generate the tangible document at the selected output destination. The separator page is then routed to the selected output destination in accordance with the output destination data corresponding to the electronic document such that the tangible document and the separator page are rendered at the output destination.

### BACKGROUND OF THE INVENTION

The subject application is directed to a system and method for generating separator pages. More particularly, the subject application is directed to a system and method for generating separator pages in a multi-user document processing environment in order to separate one user's document processing job from another user's job.

The purchasing and maintenance of document processing devices, such as printers, plotters or other document rendering devices, is costly. In addition to the cost of the basic equipment, there are costs associated with consumables, such as ink, toner, electricity or paper. There are also maintenance issues for repair or other upkeep. Therefore, it is common for multiple users to share document processing devices.

One common mechanism for sharing such devices includes having multiple users with access via a network. Each user can see a document processing device as a resource on their own workstation. Each user can send electronic documents to the shared device for processing.

One problem with shared peripherals is many users may send documents for processing concurrently. In addition, multiple completed document processing jobs may all be sitting on a single output tray, making it difficult for users to distinguish between jobs.

One solution for alleviating the afore-noted problem is by use of a separator page. Such a page is inserted between document processing jobs, and allows users to distinguish between their own jobs, or between their jobs and those of another user.

More recently, document processing devices, such as printers, have become more sophisticated. For example, it is common for such devices to have multiple or alternative output trays. Conventional separator pages may default to a certain output tray, requiring a user to make manual adjustments in the event a document output is made to one or more specified output destinations.

### SUMMARY OF THE INVENTION

In accordance with one embodiment of the subject application, there is provided a system and method for generating separation pages.

Further, in accordance with one embodiment of the subject application, there is provided a system and method for generating separator pages in a multi-user document processing environment in order to separate one user's document processing job from another user's job.

Still further, in accordance with one embodiment of the subject application, there is provided a system for generating separation pages. The system comprises means adapted for receiving a document output instruction corresponding to the generation of a tangible document from an electronic document and means adapted for receiving a separator page generation instruction. The system further comprises means adapted for receiving an output destination instruction corresponding to the electronic document, which output destination instruction corresponds to a selected output destination for the tangible document from a plurality thereof and means adapted for generating a separator page in accordance with a received separator page generation instruction. The system also includes means adapted for routing the electronic document so as to generate the tangible document at the selected output destination and means adapted for routing a separator page to the selected output destination in accordance with output destination data corresponding to the electronic document such that the tangible document and the separator page are rendered at the output destination.

In one embodiment of the subject application, the separator page is rendered at least one of a beginning of the tangible document and an end of the tangible document.

In another embodiment of the subject application, the system further comprises means adapted for receiving separator page content data from an associated storage and means adapted for rendering at least one separator page in accordance with received content data. Preferably, the content data includes at least one data item from the set comprising user name, document name, output tray number, date, time, and page length.

In a further embodiment of the subject application, each output destination is comprised of a unique output tray associated with a document rendering device.

In yet another embodiment of the subject application, the output destination instruction is disposed in metadata associated with the electronic document. In such an embodiment, the system further comprises means adapted for extracting the output destination data from the metadata so as to route at least one separator page to the output destination.

Further, in accordance with one embodiment of the subject application, there is provided a method for generating separator pages in accordance with the system as set forth above.

Still other advantages, aspects, and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system for generating separator pages according to one embodiment of the subject application;

FIG. 2 is a block diagram illustrating device hardware for use in the system for generating separator pages according to one embodiment of the subject application;

FIG. 3 is a functional diagram illustrating the device for use in the system for generating separator pages according to one embodiment of the subject application;

FIG. 4 is a block diagram illustrating controller hardware for use in the system for generating separator pages according to one embodiment of the subject application;

FIG. 5 is a functional diagram illustrating the controller for use in the system for generating separator pages according to one embodiment of the subject application;

FIG. 6 is a block diagram illustrating a user device for use in the system for generating separator pages according to one embodiment of the subject application;

FIG. 7 is a flowchart illustrating a method for generating separator pages according to one embodiment of the subject application; and

FIG. 8 is a flowchart illustrating a method for generating separator pages according to one embodiment of the subject application.

### DETAILED DESCRIPTION OF THE PREFERRED EMBODIMENT

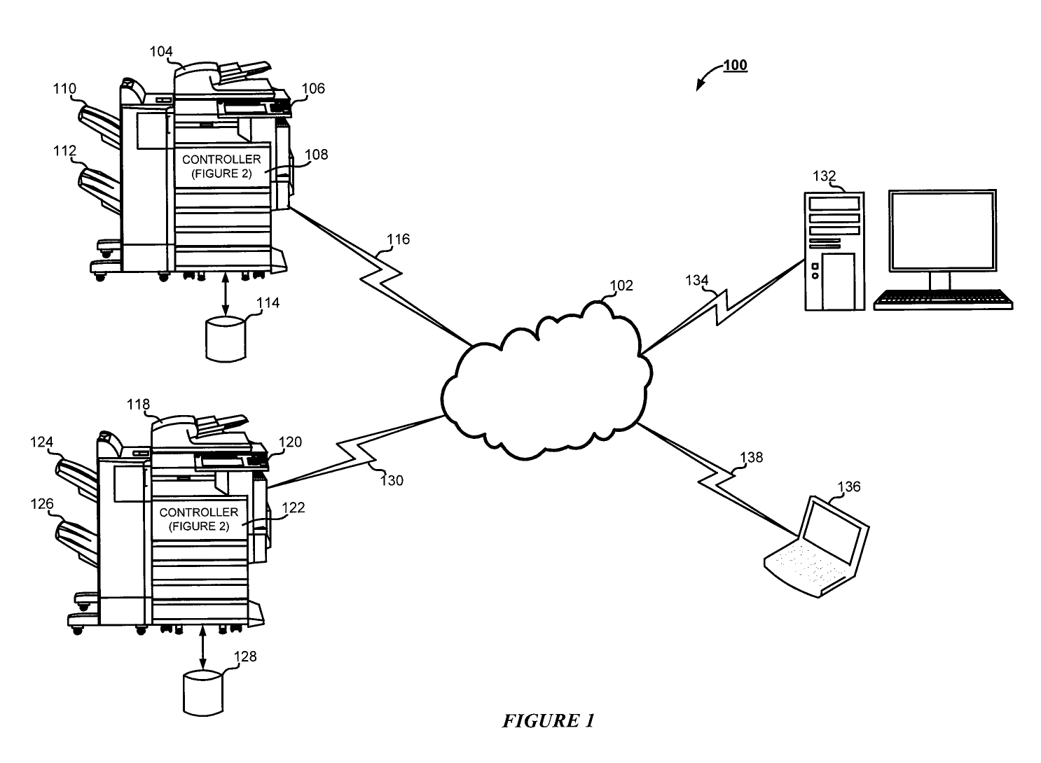

The subject application is directed to a system and method for generating separation pages. In particular, the subject application is directed to a system and method for generating separator pages in a multi-user document processing environment in order to separate one user's document processing job from another user's job. It will become apparent to those skilled in the art that the system and method described herein are suitably adapted to a plurality of varying electronic fields, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of the system 100 for generating separation pages in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

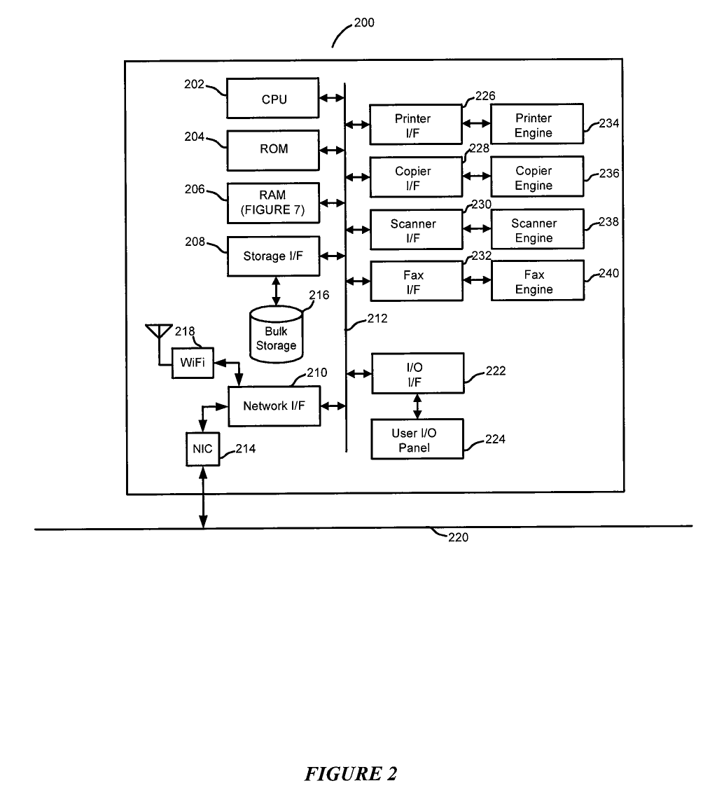

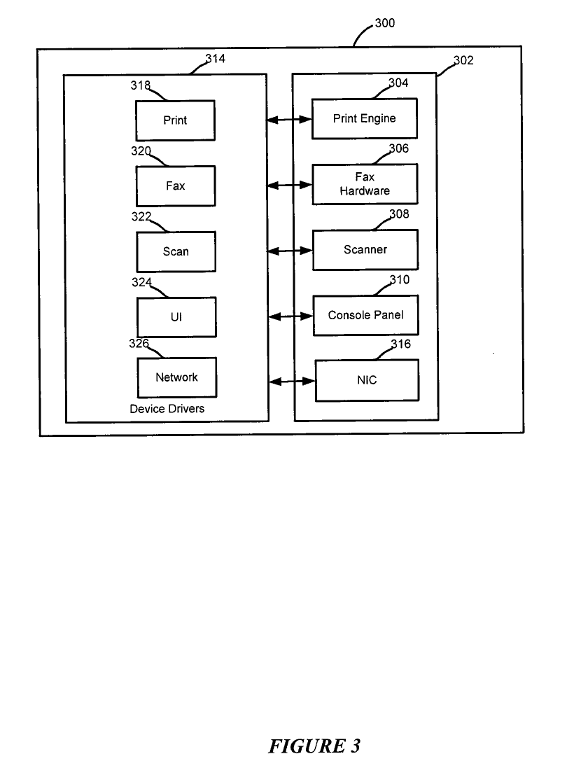

The system 100 also includes a first document rendering or processing device 104 and a second document rendering or processing device 118, depicted in FIG. 1 as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the first document processing device 104 and the second document processing device 118 are suitably adapted to provide remote document processing services to external or network devices. Preferably, the first document processing device 104 and the second document processing device 118 include hardware, software, and any suitable combination thereof, configured to interact with an associated user, a networked device, or the like. The functioning of the first document processing device 104 and the second document processing device 118 will better be understood in conjunction with the block diagrams illustrated in FIGS. 2 and 3, explained in greater detail below.

According to one embodiment of the subject application, the first document processing device 104 and the second document processing device 118 are suitably equipped to receive a plurality of portable storage media, including, without limitation, Firewire drive, USB drive, SD, MMC, XD, Compact Flash, Memory Stick, and the like. In the preferred embodiment of the subject application, the first document processing device 104 and the second document processing device 118 further include associated user interfaces 106 and 120, respectively, such as a touch-screen, LCD display, touch-panel, alpha-numeric keypad, or the like, via which an associated user is able to interact directly with the first document processing device 104 and the second document processing device 118. In accordance with the preferred embodiment of the subject application, the user interface 106 and the user interface 120 are advantageously used to communicate information to the associated user and receive selections from the associated user. The skilled artisan will appreciate that the user interface 106 and the user interface 120 comprise various components, suitably adapted to present data to the associated user, as are known in the art. In accordance with one embodiment of the subject application, the user interface 106 and the user interface 120 comprise a display, suitably adapted to display one or more graphical elements, text data, images, or the like, to an associated user, receive input from the associated user, and communicate the same to a backend component, such as a controller 108 and a controller 122, respectively, as explained in greater detail below. Preferably, the first document processing device 104 and the second document processing device 118 are communicatively coupled to the computer network 102 via suitable communications links 116 and 130, respectively. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

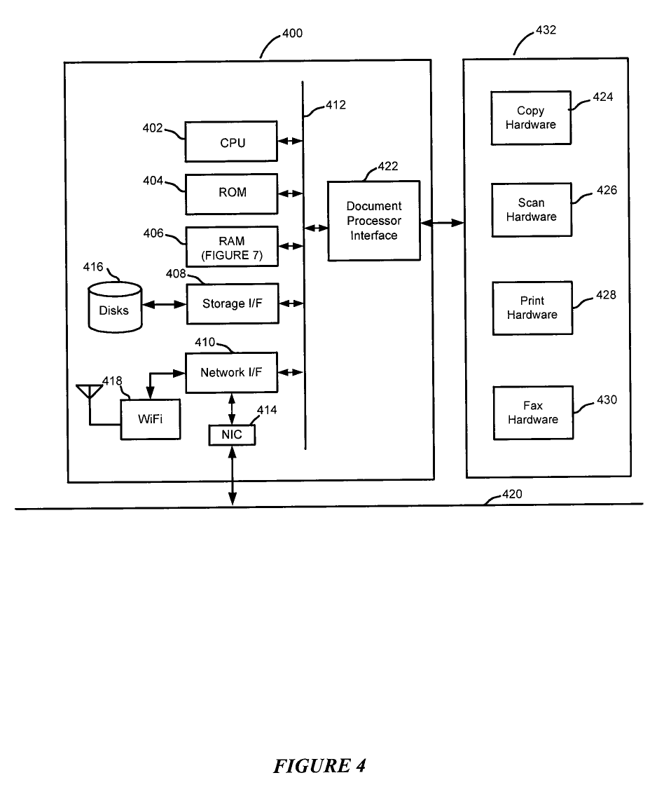

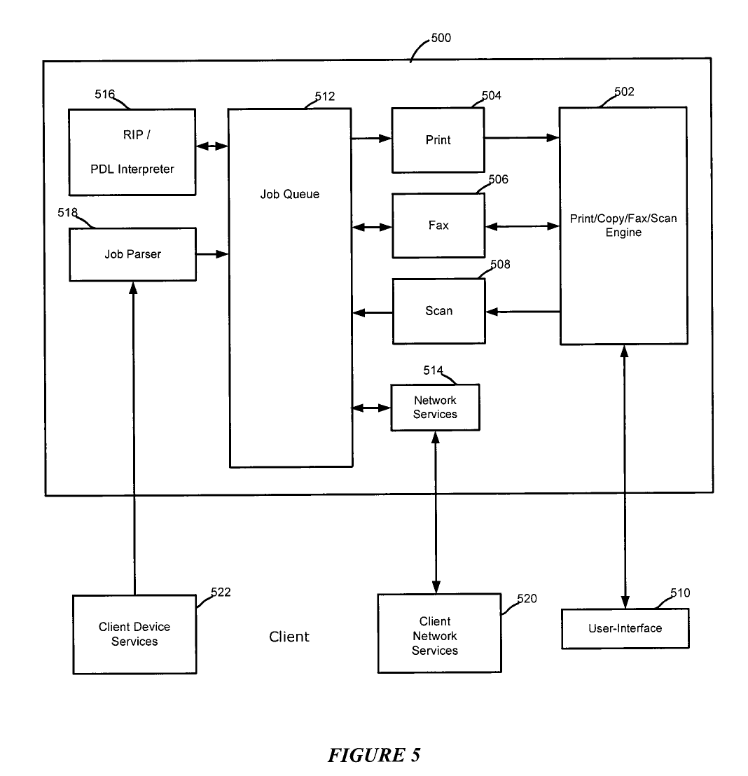

In accordance with one embodiment of the subject application, the first document processing device 104 and the second document processing device 118 further incorporate a corresponding backend component, designated as the controller 108 and the controller 122, suitably adapted to facilitate the operations of the first document processing device 104 and the second document processing device 118, as will be understood by those skilled in the art. Preferably, the controller 108 and the controller 122 are embodied as hardware, software, or any suitable combination thereof, configured to control the operations of its associated document processing device, facilitate the display of images via the corresponding user interface 106 or 120, direct the manipulation of electronic image data, and the like. For purposes of explanation, the controller 108 and the controller 122 are used to refer to any myriad of components associated with the first document processing device 104 and the second document processing device 118, including hardware, software, or combinations thereof, functioning to perform, cause to be performed, control, or otherwise direct the methodologies described hereinafter. It will be understood by those skilled in the art that the methodologies described with respect to the controller 108 and the controller 122 are capable of being performed by any general purpose computing system, known in the art, and thus the controller 108 and the controller 122 are representative of such general computing devices and are intended as such when used hereinafter. Furthermore, the use of the controller 108 and the controller 122 hereinafter are for the example embodiment only, and other embodiments, which will be apparent to one skilled in the art, are capable of employing the system and method for generating separation pages of the subject application. The functioning of the controllers 108 and 122 will better be understood in conjunction with the block diagrams illustrated in FIGS. 4 and 5, explained in greater detail below.

As shown in FIG. 1, the first document processing device 104 and the second document processing device 118 further include one or more output trays, illustrated in FIG. 1 as a first output tray 110 and a second output tray 112 associated with the first document processing device 104 and a first output tray 124 and a second output tray 126 associated with the second document processing device 118. It will be understood by those skilled in the art that the output trays 110, 112, 124, and 126 are representative of output media, i.e., paper trays, which hold tangible documents output by the first document processing device 104 and the second document processing device 118, respectively. While only two output trays are shown in FIG. 1, the skilled artisan will appreciate that the first document processing device 104 and the second document processing device 118 are capable of implementing a plurality of output trays, without departing from the scope of the subject application. In accordance with one embodiment of the subject application, either the first document processing device 104 or the second document processing device 118 are capable of being designated as an output destination, as set forth in greater detail below.

Communicatively coupled to the first document processing device 104 is a data storage device 114, and in data communication with the second document processing device 118 is a data storage device 128. In accordance with the preferred embodiment of the subject application, the data storage device 114 and the data storage device 128 are any mass storage device known in the art including, for example and without limitation, magnetic storage drives, hard disk drives, optical storage devices, flash memory devices, or any suitable combination thereof. In the preferred embodiment, the data storage device 114 and the data storage device 128 are suitably adapted to store document data, image data, electronic database data, or the like. It will be appreciated by those skilled in the art that while illustrated in FIG. 1 as being a separate component of the system 100, the data storage devices 114 and 128 are capable of being implemented as internal storage component of the first document processing device 104 or second document processing device 118, a component of the controller 108 or controller 122, or the like, such as, for example and without limitation, an internal hard disk drive, or the like. In accordance with one embodiment of the subject application, the data storage device 114 and the data storage device 128 include data representative of separator page content for output as a separator page.

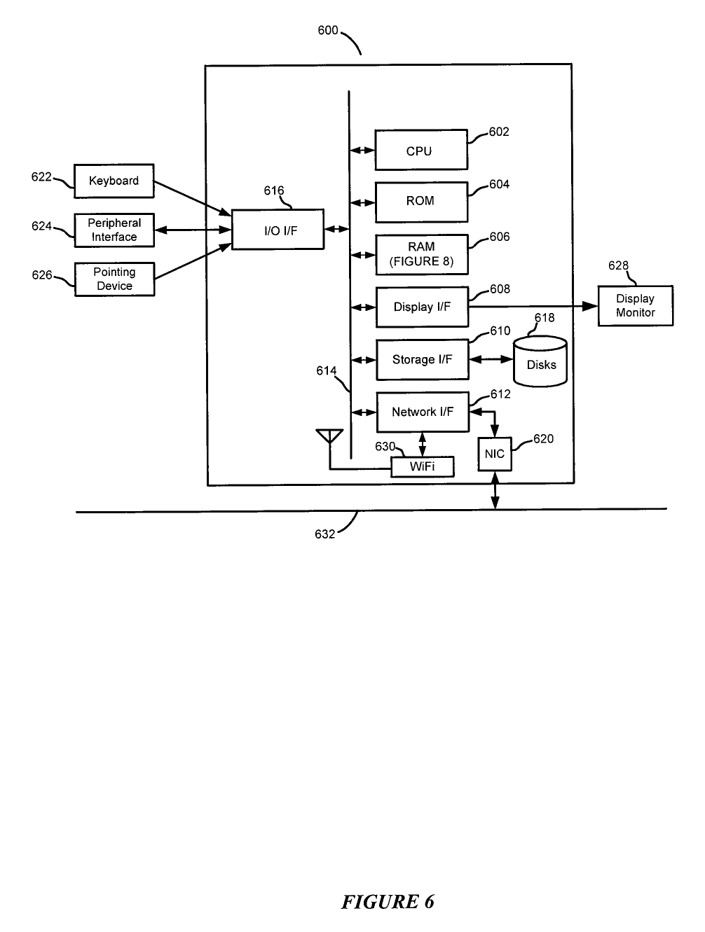

The system 100 illustrated in FIG. 1 further depicts a first user device 132 and a second user device 136, in data communication with the computer network 102 via communication links 134 and 138, respectively. It will be appreciated by those skilled in the art that the first user device 132 is shown in FIG. 1 as a workstation and the second user device 136 is shown as a laptop computer for illustration purposes only. As will be understood by those skilled in the art, the user devices 132 and 136 are representative of any personal computing devices known in the art, including, for example and without limitation, computer workstations, personal computers, laptop computers, personal data assistants, web-enabled cellular telephones, smart phones, proprietary network devices, or other web-enabled electronic devices. The functioning of the controller 108 will better be understood in conjunction with the block diagram illustrated in FIG. 6, explained in greater detail below. The communication links 134 and 138 are any suitable channels of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the first and second user devices 132 and 136 are suitably adapted to generate and transmit electronic documents, document processing instructions, user interface modifications, upgrades, updates, personalization data, or the like, to the first document processing device 104, or any other similar device coupled to the computer network 102.

Turning now to FIG. 2, illustrated is a representative architecture of a suitable device 200, illustrated in FIG. 1 as the first document processing device 104 and the second document processing device 118, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the server 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device for use in connection with the disclosed system. FIG. 3 illustrates suitable functionality of the hardware of FIG. 2 in connection with software and operating system functionality as will be appreciated by one of ordinary skill in the art. The document processing device 300, depicted in FIG. 1 as the first document processing device 104 and the second document processing device 118, suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as controller 108 and controller 122, on which operations of the subject system 100 are completed. The skilled artisan will understand that the controllers 108 and 122 are representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, the network interface subsystem 410 suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purpose document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600 for use in connection with the subject system. It will be appreciated by those skilled in the art that the diagram shown in FIG. 6 is representative of any user device, e.g., user devices 132 and 136, in accordance with the subject application and the various components of the workstation 600 illustrated in FIG. 6 is for example purposes only. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

In operation, a document output instruction is received corresponding to the generation of a tangible document from an electronic document. A separator page instruction is then received. An output destination instruction corresponding to the electronic document, corresponding to a selected output destination for the tangible document is then received. A separator page is then generated in accordance with the received separator page generation instruction. The electronic document is then routed so as to generate the tangible document at the selected output destination. The separator page is then routed to the selected output destination in accordance with the output destination data corresponding to the electronic document such that the tangible document and the separator page are rendered at the output destination. In accordance with one embodiment of the subject application, the output destination instruction is disposed in metadata associated with the electronic document. In such an embodiment, the destination is extracted from the metadata and used for routing of the separator page to the appropriate output destination

In accordance with one example embodiment of the subject application, a user associated with the first user device 132 or the second user device 136, requests an electronic output via a printer driver or other suitable interface associated with the corresponding user device 132 or 136. For purposes of this example, reference will be made hereinafter to a user associated with the first user device 132. It will be appreciated by those skilled in the art that a suitable printer driver, corresponding to a selected document processing device, e.g., the first document processing device 104 or the second document processing device 118, an application resident on the user device 132, or the like, presents a user interface to the user enabling the user to select an output of a selected electronic document. In accordance with the user's selection to output a tangible document from the electronic document, the printer driver of the user device 132 generates print job data. As will be appreciated by those skilled in the art, print job data corresponds, for example and without limitation, to data capable of being understood by the receiving document processing device, i.e., the first document processing device 104 or the second document processing device 118. The user is then able to select a separator page be output in accordance with the print job. That is, the user is able to designate a separator page be output just prior to or just after the print job, so as to separate the tangible document from tangible documents corresponding to other print jobs from other users.

Thus, a determination is made by the printer driver whether a separator page has been requested. When no separator page is desired by the user, the printer driver directs the user device 132 to communicate the print job data to the selected document processing device, e.g., the first document processing device 104 or the second document processing device 118. Preferably, this print job data is communicated via the computer network 102, however the skilled artisan will appreciate that a direct connection between the document processing device 104 and the user device 132 is also capable of being used in accordance with the subject application.

When a separator page is desired, as indicated by user selection via the user interface associated with the printer driver, the user is prompted, via a suitable interface, to select an output destination from a plurality of output destinations available on the selected document processing device, i.e., the first document processing device 104 or the second document processing device 118. That is, the user selects one of the output trays, e.g., tray 110, tray 112, tray 124 or tray 126, or a particular document processing device, e.g., the first device 104 or the second device 118, as the output destination. It will be understood by those skilled in the art that such a selection corresponds to the output destination of both the tangible version of the print job data and the separator page. In accordance with one embodiment of the subject application, the output destination is capable of including, for example, either the first or second document processing device 104 or 118, dependent upon to which device the document is sent. Thus, the skilled artisan will appreciate, for example, that the user selects the first document processing device 104 due to processing ability, but designates the second document processing device 118 as an output destination because of the type of paper available on the second device 118. Thus, the user makes use of the processing capabilities of the first device 104 and the output media available at the second document processing device 118. According to one embodiment of the subject application, the destination selected by the user is disposed in metadata, generated by the printer driver and associated with the electronic document. The skilled artisan will appreciate that in such an embodiment, the output destination data is then extracted a suitable component of the selected document processing device, e.g., 104 or 118, and used to determine the output destination for the separator page.

Separator page content data is then retrieved by the printer driver. In accordance with one embedment of the subject application, the content data is suitably retrieved from storage is associated with the user device 132. According to another embodiment of the subject application, the content data is capable of being retrieved by the first document processing device 104 from the data storage device 114, or the second document processing device 118 from the data storage device 128. It will be understood by those skilled in the art that in such an embodiment, the gathering of the content data occurs after receipt of the print job data by the first document processing device 104 or the second document processing device 118. The content data includes, for example and without limitation, data representative of a username, a print job number, an output tray number, a document identification number, or the like.

A separator page is then generated in accordance with the retrieved content data. That is, the printer driver generates separator page print data corresponding to a separator page to be output by the first document processing device 104 or the second document processing device 118, in association with the tangible form of the electronic document. The separator page data is then communicated, via the computer network 102, from the first user device 132 to the first document processing device 104 or the second document processing device 118. The print job data is then communicated to the first document processing device 104 or second document processing device 118 for output thereon.

In accordance with one particular embodiment, an associated user is able to request a separator page directly using the user interface 106 or user interface 120 associated with the first document processing device 104 or the second document processing device 118, respectively. Thus, the user is capable of submitting a document processing request via the user interface 106 or 120 and thereafter requesting the inclusion of a separator page in the output of the document. For example, the user inserts a portable storage media into the document processing device 104, identifies the document's current network location, identifies the document location in the data storage device 114, or the like, from which the controller 108, or other suitable backend component of the document processing device 104, uses to generate print job data. The output destination, i.e., tray 110, tray 112, or the second document processing device 118, is then selected via a graphical prompt displayed to the user on the user interface 106. The controller 108, via the user interface 106, then prompts the user to select a separator page or to output the document without the separator page. When a separator page is selected, the controller 108 retrieves, from the document itself, from the data storage device 110, from the user, or a combination thereof, content data for incorporation into the separator page. Thereafter, a separator page is generated inclusive of the content data is generated. The separator page and the document corresponding to the document processing request are output by the document processing device 104 at the selected output destination, i.e., at tray 110, tray 112, or at the second document processing device 118.

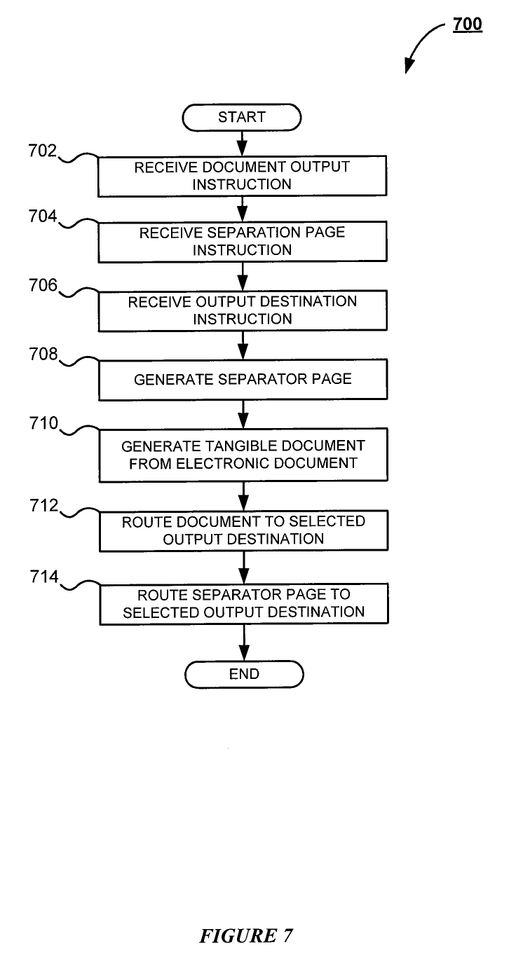

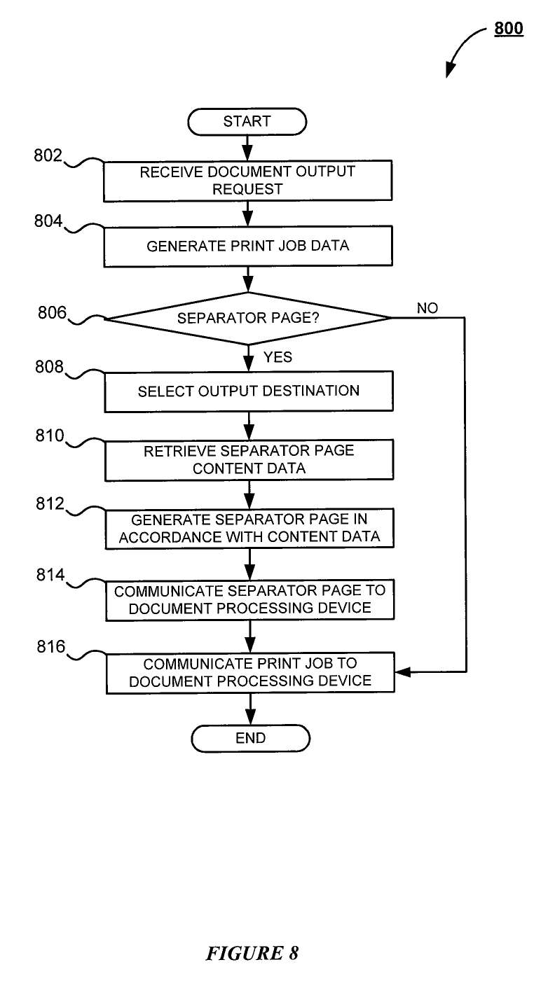

The skilled artisan will appreciate that the subject system 100 and components described above with respect to FIG. 1, FIG. 2, FIG. 3, FIG. 4, FIG. 5, and FIG. 6 will be better understood in conjunction with the methodologies described hereinafter with respect to FIG. 7 and FIG. 8. Turning now to FIG. 7, there is shown a flowchart 700 illustrating a method for generating separation pages in accordance with one embodiment of the subject application. For purposes of example only, reference is made in FIG. 7 to the first document processing device 104. The skilled artisan will appreciate that the second document processing device 118 is equally capable of being implemented in accordance with the methodology set forth in FIG. 7. Beginning at step 702, a document output instruction is received by the controller 108 or other suitable backend component of the first document processing device 104. It will be appreciated by those skilled in the art that such an instruction is capable of originating from the first user device 132 or the second user device 136, communicated to the first document processing device 104 via the computer network 102. At step 704, the controller 108, or other suitable backend component of the first document processing device 104 receives a separation page generation instruction. It will be appreciated by those skilled in the art that the separation page generation instruction and the document output instruction are capable of being received in any order and the flow of operations illustrated in FIG. 7 is for illustration purposes only.

At step 706, an output destination instruction is then received corresponding to the electronic document received by the first document processing device 104. Preferably, the output destination instruction corresponds to a selected output destination for the tangible document. In accordance with one embodiment of the subject application, the output destination corresponds to an output tray associated with the document processing device 104, e.g., the first output tray 110 or the second output tray 112, or another document processing device, e.g., the second document processing device 118. In accordance with another embodiment of the subject application, the output destination instruction is disposed in metadata associated with the electronic document. In such an embodiment, the destination is extracted from the metadata and used for routing of the separator page to the appropriate output destination. The first document processing device 104, via the controller 108, then generates the separator page in accordance with the received separator page instruction at step 708. A tangible document is then generated from the received electronic document at step 710. At step 712, the document is routed to the selected output destination. At step 714, the separator page is routed to the selected output destination in accordance with output destination data corresponding to the electronic document such that the tangible document and the separator page are rendered at the output destination.

For example, the first document processing device 104 receives an electronic document and separator page instructions from the first user device 132. The document processing device 104 also receives a selected output destination, e.g., the first output tray 110. The document processing device 104 then generates the separator page and the electronic document in tangible form, routing both to the first output tray 110.

As a further example, the document processing device 104 receives an electronic document and separator page instructions from the second user device 136. The document processing device 104 also receives a selected output destination, e.g., the second document processing device 118. The first document processing device 104 then generates the separator page and the electronic document in tangible form, routing both to the second document processing device 118 for output thereon.

Referring now to FIG. 8, there is shown a flowchart 800 illustrating a method for generating separation pages as viewed from the point of view of a printer driver in accordance with one embodiment of the subject application. For purposes of example only, reference is made in FIG. 8 to the first document processing device 104. The skilled artisan will appreciate that the second document processing device 118 is equally capable of being implemented in accordance with the methodology set forth in FIG. 8. The method depicted in the flowchart 800 of FIG. 8 begins at step 802, whereupon a printer driver, associated with the first user device 132 or the second user device 136, receives a document output request. It will be appreciated by those skilled in the art that for example purposes only, reference is made herein with respect to FIG. 8 as applying to the first user device 132. It will be apparent to those skilled in the art that the subject application is suitably adapted to a multi-user environment, wherein multiple user devices communicate document output requests to one or more document processing devices. At step 804, the printer driver, or other suitable component of the first user device 132, generates print job data corresponding to a selected electronic document for output by the selected document processing device, e.g., the first document processing device 104 or the second document processing device 118. Preferably the print data corresponds to data capable of being understood and processed by the selected document processing device, e.g., the first document processing device 104, as will be understood by those skilled in the art.

A determination is then made at step 806 whether the user requesting the print job has requested the generation of a separator page. In accordance with one embodiment of the subject application, such a request is suitably received via a graphical user interface associated with the printer driver and displayed to the user via the user device 132. According to such an embodiment, the user is able to request such a separator page by selecting a suitable graphical element associated with the user interface. When no separator page is requested by the user, flow proceeds to step 816, whereupon the print job data is communicated to the first document processing device 104 for output thereon. It will be understood by those skilled in the art that the print data is capable of being communicated to the first document processing device 104 via the computer network 102, via a direct connection between the user device 132 and the first document processing device 104, or the like.

Returning to step 806, when it is determined that the user has selected a separator page, flow progresses to step 808, whereupon the user is prompted to select an output destination. In accordance with one embodiment of the subject application, the user is presented, via the graphical user interface associated with the printer driver, a graphical element representative of the output trays 110 and 112, and other document processing devices, e.g., device 118, coupled to the computer network 102 and capable of functioning in accordance with the subject application. From this graphical display, the user is able to select the desired output destination, for example the fist output tray 110 or the second output tray 112. According to one embodiment of the subject application, the destination selected by the user is disposed in metadata, generated by the printer driver and associated with the electronic document. The skilled artisan will appreciate that in such an embodiment, the output destination data is then extracted by the controller 108 or other suitable component of the selected document processing device, e.g., 104 or 118, and used to determine the output destination for the separator page. At step 810, separator page content data is retrieved. In accordance with one embodiment of the subject application, the content data includes, for example and without limitation, a user name, a document name, an output tray number, the date, time, page length, department codes, or the like. It will be appreciated by those skilled in the art that such content data is capable of being retrieved by the printer driver from storage associated with the user device 132, from the data storage device 114 via the computer network 102, or the like.

A separator page is then generated at step 812 in accordance with the content data. The skilled artisan will appreciate that the printer driver composes a suitable data file, e.g., a page description language file, inclusive of the content data and capable of being output by the first document processing device 104. The separator page data is then communicated, via the computer network 102, to the first document processing device 104 at step 814. Thereafter, at step 816, the print job is communicated to the first document processing device 104 via the computer network 102. It will be understood by those skilled in the art that such communication is capable of occurring via a direct connection between the user device 132 and the first document processing device 104, as are known in the art. It will be appreciated by those skilled in the art that the user is capable of selecting the second document processing device 118 as the output destination, thereby, for example, using processing of the first document processing device 104 and output media of the second document processing device 118.

In accordance with one particular embodiment, an associated user is able to request a separator page via the user interface 106 or 120 associated with the first document processing device 104 or second document processing device 118, respectively. That is, the user is able to request a document processing job via the user interface 106 or 120, e.g., via a portable storage media, network storage facility, electronic mail, or the like, and request that the first document processing device 104 or second document processing device 118 insert a separator page. Thus, the controller 108 or 122, or other suitable backend component of the corresponding document processing device 104 or 118, retrieves content data, as set forth above, from the appropriate data storage device 110 or 128 and generates a separator page. Thereafter, the separator page and the document processing request are then output by the selected document processing device, e.g., the first document processing device 104 or the second document processing device 118.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A separator page generating system comprising:
means adapted for receiving an document output instruction corresponding to generation of a tangible document from an electronic document;
means adapted for receiving a separator page generation instruction;
means adapted for receiving an output destination instruction corresponding to the electronic document, which output destination instruction corresponds to a selected output destination for the tangible document from a plurality thereof;
means adapted for generating a separator page in accordance with a received separator page generation instruction;
means adapted for routing the electronic document so as to generate the tangible document at the selected output destination; and
means adapted for routing a separator page to the selected output destination in accordance with output destination data corresponding to the electronic document such that the tangible document and the separator page are rendered at the output destination.

2. The separator page generating system of claim 1 wherein the separator page is rendered at least one of a beginning of the tangible document and an end of the tangible document.

3. The separator page generating system of claim 1 further comprising:
means adapted for receiving separator page content data from an associated storage; and
means adapted for rendering at least one separator page in accordance with received content data.

4. The separator page generating system of claim 3 wherein the content data includes at least one data item from the set comprising user name, document name, output tray number, date, time and page length.

5. The separator page generating system of claim 1 wherein each output destination is comprised of a unique output tray associated with a document rendering device.

6. The separator page generating system of claim 1 wherein the output destination instruction is disposed in metadata associated with the electronic document, and wherein the system further comprises means adapted for extracting the output destination data from the metadata so as to route at least one separator page to the output destination.

7. A method for generating separator pages comprising the steps of:
receiving a document output instruction corresponding to generation of a tangible document from an electronic document;
receiving a separator page generation instruction;
receiving an output destination instruction corresponding to the electronic document, which output destination instruction corresponds to a selected output destination for the tangible document from a plurality thereof;
generating a separator page in accordance with a received separator page generation instruction;
routing the electronic document so as to generate the tangible document at the selected output destination; and
routing a separator page to the selected output destination in accordance with output destination data corresponding to the electronic document such that the tangible document and the separator page are rendered at the output destination.

8. The method for generating separator pages of claim 7 wherein the separator page is rendered at least one of a beginning of the tangible document and an end of the tangible document.

9. The method for generating separator pages of claim 7 further comprising the steps of:
receiving separator page content data from an associated storage; and
rendering at least one separator page in accordance with received content data.

10. The method for generating separator pages of claim 9 wherein the content data includes at least one data item from the set comprising user name, document name, output tray number, date, time and page length.

11. The method for generating separator pages of claim 7 wherein each output destination is comprised of a unique output tray associated with a document rendering device.

12. The method for generating separator pages of claim 7 wherein the output destination instruction is disposed in metadata associated with the electronic document, and wherein the method further comprises the step of extracting the output destination data from the metadata so as to route at least one separator page to the output destination.

13. A computer-implemented method for generating separator pages comprising the steps of:
receiving a document output instruction corresponding to generation of a tangible document from an electronic document;
receiving a separator page generation instruction;
receiving an output destination instruction corresponding to the electronic document, which output destination instruction corresponds to a selected output destination for the tangible document from a plurality thereof;
generating a separator page in accordance with a received separator page generation instruction;
routing the electronic document so as to generate the tangible document at the selected output destination; and
routing a separator page to the selected output destination in accordance with output destination data corresponding to the electronic document such that the tangible document and the separator page are rendered at the output destination.

14. The computer-implemented method for generating separator pages of claim 13 wherein the separator page is rendered at least one of a beginning of the tangible document and an end of the tangible document.

15. The computer-implemented method for generating separator pages of claim 13 further comprising the steps of:
receiving separator page content data from an associated storage; and
rendering at least one separator page in accordance with received content data.

16. The computer-implemented method for generating separator pages of claim 15 wherein the content data includes at least one data item from the set comprising user name, document name, output tray number, date, time and page length.

17. The computer-implemented method for generating separator pages of claim 13 wherein each output destination is comprised of a unique output tray associated with a document rendering device.

18. The computer-implemented method for generating separator pages of claim 13 wherein the output destination instruction is disposed in metadata associated with the electronic document, and wherein the method further comprises the step of extracting the output destination data from the metadata so as to route at least one separator page to the output destination.
